(19) United States
(12) Patent Application Publication
(10) Pub. No.: US 2002/0062572 A1
(43) Pub. Date: May 30, 2002

(54) METHOD OF DETERMINING THE SHAPE OF A PROBE FOR A STYLUS PROFILOMETER

(76) Inventors: Jeffrey Bruce Bindell, Orlando, FL (US); Erik Cho Houge, Orlando, FL (US); Larry E. Plew, St. Cloud, FL (US); Terri Lynn Shofner, Casselberry, FL (US); Fred Anthony Stevie, Orlando, FL (US)

Correspondence Address: Sheldon H. Parker, 300 Preston Avenue, Suite 300, Charlottesville, VA, 22902, US

(21) Appl. No.: 09/727,380

(22) Filed: Nov. 30, 2000

(51) Int. Cl. G01B 5/20

(52) U.S. Cl. 33/546; 33/559

(57) ABSTRACT

A method of characterizing the shape of a probe element for a scanning probe microscope including using two test pattern surfaces of known configuration, the first surface having a pointed wedge-shaped tip and the second surface having an hour-glass type cross-section, wherein the surfaces are scanned to generate scan lines having curved transition zones that are geometrically matched in order to generate a probe characteristic representation curve, wherein the probe characteristic representation curve is a graphic representation of the shape of the tip of the probe.

### FIELD OF THE INVENTION

The invention relates to the method of determining and monitoring the shape of the tip of a scanning probe microscope, and more particularly to the determination of the shape of the tip of the probe of a stylus nanoprofilometer, by scanning the tip over two known characterizers.

### BACKGROUND OF THE INVENTION

The probative portion or probe of a scanning probe microscope is subject to a constantly changing geometrical relationship between the tip and the sample. The performance of a surface profiler depends on the shape of the stylus tip, that is, the surface contacting portion of the stylus. The response of a stylus profilometer to a sample surface is in general, a complicated nonlinear function of the shape of both the sample and the stylus. Quantitative extraction of the sample shape from the scan requires precise knowledge of the stylus shape. Changes in the shape of the probe, caused by wear, erosion or contamination during scanning, can introduce a corresponding error in the surface measurement. The durability of the stylus depends on its shape, its composition, the composition of the sample, and the force sensor employed. Cylindrical, silica glass probes etched from an optical fiber or formed by FIB milling, can be used in conjunction with a balance beam force sensor with a sensitivity of approximately 10 nN. The probe tips can be used for extended periods of time on samples ranging from photoresist to silicon nitride with very little change in their shape from either erosion or contamination. Since all stylus microscopes require the stylus to be in close proximity to the solid sample, changes in the stylus during scanning are practically unavoidable.

The scanning probe for the stylus profilometer can have a variety of predetermined shapes. The preferred shape for certain applications has a right pair of right angle corners, as characterized by cylinders. As employed herein, the term cylinder is intended to include all polygonal configurations from circular to triangular. Preferred configurations are the circle and the square cross-section. The probe tip's end surface is as close to a planar surface as possible, with its plane at a right angle to the longitudinal axis of the cylinder. In the manufacture of such probes, the actual configuration can vary from the theoretical goal, and during use, the probe configuration can change due to repeated contacts with the surface that is being probed. Degradation of the tip proceeds at an unpredictable rate. Knowledge of the actual shape of the probe edge is critical to the determination of the configuration of the surface that is being probed.

### SUMMARY OF THE INVENTION

It has now been found that the subjective aspect to the defining of the shape of the probe tip from the test patterns graphs of the flared surface test and the sharp edged surface test, can be resolved mathematically to produce a result with a high degree of reproducibility. The reproducibility enables the accurate monitoring of progressive changes with time, of the tip surface characteristics.

The shape of the probe edge is determined through the use of two test pattern surfaces of known configuration. The first surface has a pointed tip, as is characteristic of cones and wedges. The apex angle is not narrowly critical, but it is preferred that it is an acute angle. The second test pattern surface is flared, in that it has an hour glass type of cross-section. In essence it is comparable to a pair of truncated cones or wedges having the truncated surfaces jointed together. The upper surface of the test surface is planar with essentially sharply defined outer edges.

In the hour glass shaped test surface the sharply defined outer edges serve to make contact with the probe at a single point during the phase of the test procedure in which the probe tip is rising vertically until the probe is above elevation of the test surface and can continue a horizontal travel parallel to the plane of the planar surface of the test surface. The same single contact point measurement is attained during the downward travel of the probe after the probe has cleared the second outer edge of the test surface.

The width of the planar test surface is not critical since this variable can be mathematically eliminated when the readings from the two tests are merged. Similarly, the extent to which the wedge shaped test surface deviates from a perfect point is not narrowly critical, since this variable can also be mathematically eliminated when the readings from the two tests are merged. The two tests are compared to determine the two regions of each of the resultant curves that represent the test readings, that are substantially identical.

It is the merging of the two readings that produces the desired final analysis. The test results produce a first pattern that has a pair of curved transition zones when running the wedge shaped surface test and a corresponding pair of curved transition zones when running the hour glass shaped surface test.

While the graph of the readings from the two test can be visually overlayed to produce the true shape of the probe, the visualization process is subjective and can vary from person to person, and from time to time with the same person.

### BRIEF DESCRIPTION OF THE DRAWINGS

For a more complete understanding of the present invention, reference is now made to the following descriptions taken in conjunction with the accompanying drawings, in which:

FIG. 1 is an illustration of a first type of standard calibration grating;

FIG. 2 is an illustration of a second type of standard calibration grating;

FIG. 3 is an illustration of a probe scan line shown in relation to the first type of calibration grating;

FIG. 4 is an illustration of a probe scan line shown in relation to the second type of calibration grating;

FIG. 5 represents the scan line of FIG. 1 overlayed on the scan line of FIG. 2;

FIG. 6 represents the matching of a first portion of the two scan lines;

FIG. 7 represents the matching of a second portion of the two scan lines;

FIG. 8 represent the combined matching of the two scan lines;

FIG. 9 represents the shape of the probe tip based on the scan line matching; and

FIG. 10 is an illustration of a probe tip corresponding to the shape illustrated in FIG. 9.

### DESCRIPTION OF THE PREFERRED EMBODIMENTS OF THE INVENTION

Amorphous silica is a rugged probe material and does not suffer plastic deformation typical of metal probes. Some materials do erode the glass, but the erosion rate is not high.

All lateral motion of the probe occurs only when the probe is retracted from the surface that is being studied. The probe touches the surface only once per data point. By way of example, the force sensor can be a silicon plate, 10 mm×5 mm, with two ball bearings attached to opposing edges. The ball bearings serve as pivots and as a means to hold the plate to the scan actuator with the magnet. Capacitors on each side of the pivot hold the plate in balance by means of a variable electric field controlled by a force-balance servo. The relatively large size of the sensor makes it compatible with a wide range of probe tips.

The force sensor is a one-dimensional sensor sensitive mainly to vertical forces. For each data point, the probe touches the surface once with a preset repulsive force. Each touch represents a pixel, with the resolution determined by the spacing of the pixels. The probe tip is made from an optical fiber known a z-fiber, that is made by drawing a perform down on to a pure silica rod. The fiber core is thus pure silica. The fiber is formed into a probe tip though cleaving and wet chemical etching.

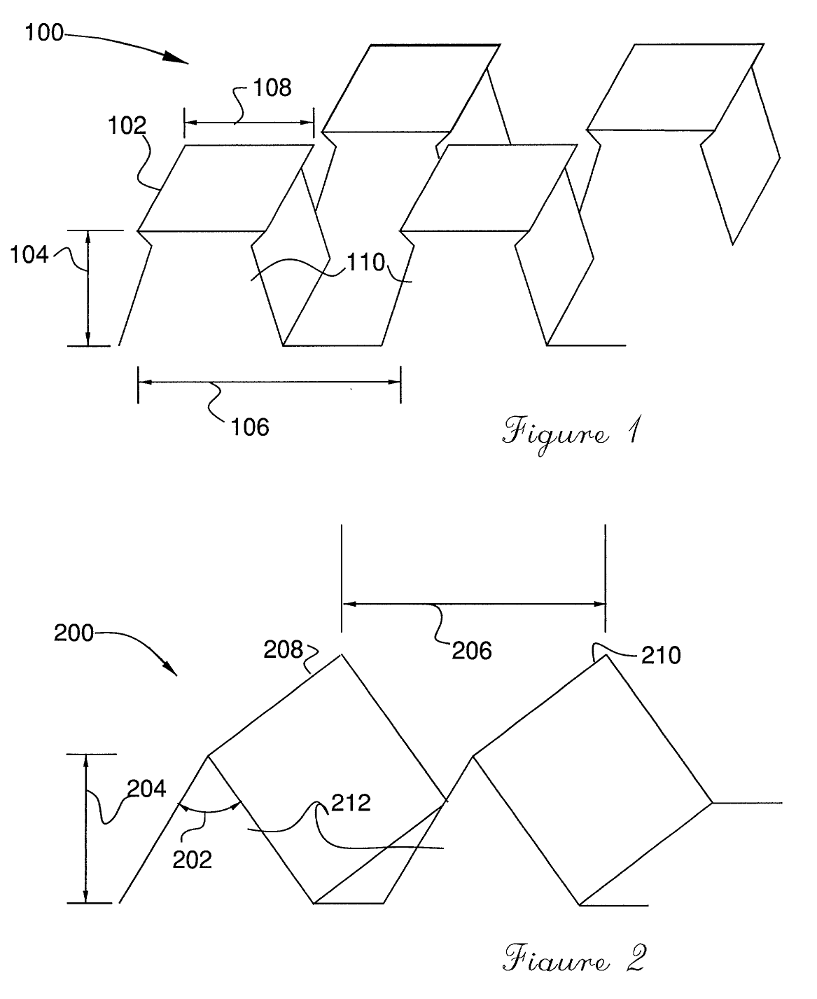

The heart of any scanning probe microscope is the tip structure. The response of a sample surface to the tip is a complex nonlinear function combining the actual sample surface and the shape of the probe. To use a scanning probe microscope for inline metrology the shape, size and morphology of the probe that is interacting with the sample must be known to be able to extract the real shape of the sample surface from the raw data. The current approach to reconstruct a point matrix representative of the tip shape is done by hand. This adds ambiguity and error and is not realistic for an inline metrology tool. The present invention solves three problems (1) the automated determination of a tip shape by the reconstruction from known structures (2) monitoring the shape of the probe over time and (3) determining when the probe has varied enough such that it should be replaced. The procedure commences with the scanning over two known structures or characterizers. The characterizers are known standards, such as available from NT-MDT, Moscow, Russia. One type of characterizer is illustrated in FIG. 1, and a second type is illustrated in FIG. 2. The first type indicated generally as 100 in FIG. 1, is a flared structure commonly used to measure the shape of the probes' flanks. NT-MDT indicates that silicon calibration gratings of TGX series, as illustrated in FIG. 1, are applied as test structure for lateral calibration of SPM scanners, assessment of lateral non-linearity, detection of hysteresis and piezoceramics creep-effect. The projections 110 can have a height 104, of about 1 um. The distance between edges 102 is represented by arrow 108 and can be 1.5 um. The distance between leading edges of two adjacent projections 110, as indicated by arrow 108, can be 3.0 um. The characterizer of FIG. 2 indicated generally as 200, is an elongated structure having a triangular face 212, and thus providing an elongated edge. The height as represented by arrow 204 can be 1.5 um. The triangular type is commonly employed to measure the shape of the apex of the probe. NT-MDT indicates that silicon calibration gratings of TGG series, as illustrated in FIG. 2, are applied as test structure for lateral calibration of SPM scanners, assessment of angular distortion. These structures were fabricated from etched silicon. The apex angle 202 can be 70 degrees and the distance between apices 208 and 210, as indicated by arrow 206, can be 3 um.

Scanning over these two structures creates a point matrix in plane x-z. X is the direction f of the scan and z is the height of the scan. If the spacing between pixels is small enough the result is a virtual line scan or cross section of the feature. The raw data for scans across the sample surfaces of the two characterizers yields the raw data shown in FIGS. 3 and 4. The information in the scan illustrated in FIG. 3 is the contribution of the known feature or characterizer plus the geometrical identity of the tip.

A problem that is overcome by the present invention relates to the inability to directly extract a tip shape from the data derived from the scanning of the two characterizers. It has now been determined that since the same tip scanned both characterizers, there should be an area where the point matrices overlap. A function is defined to calculate a minima at the location where the contributions of the tip geometry match between the point matrix of the scans lines of FIGS. 3 and 4.

The matching of the scan lines is accomplished by defining an equation that maximizes the overlap region between the two matrixes. The inverse deviation sum squared value between the two data sets works well for the matching algorithm. The matching of the scan lines can be accomplished using commercially available software, such as the software available from Civilized Software, 12109 Heritage Park Circle, Silver Spring, Md., 20906, and in any event, the mathematical calculation required to match the two scan lines is well known. Civilized Software are the developers of MLAB, an advanced mathematical and statistical modeling system, for mathematical and statistical exploration, and for solving simulation and modeling problems. MLAB is used for autoregression models, boundary-value problems, cluster analysis, contour maps, and curve-fitting.

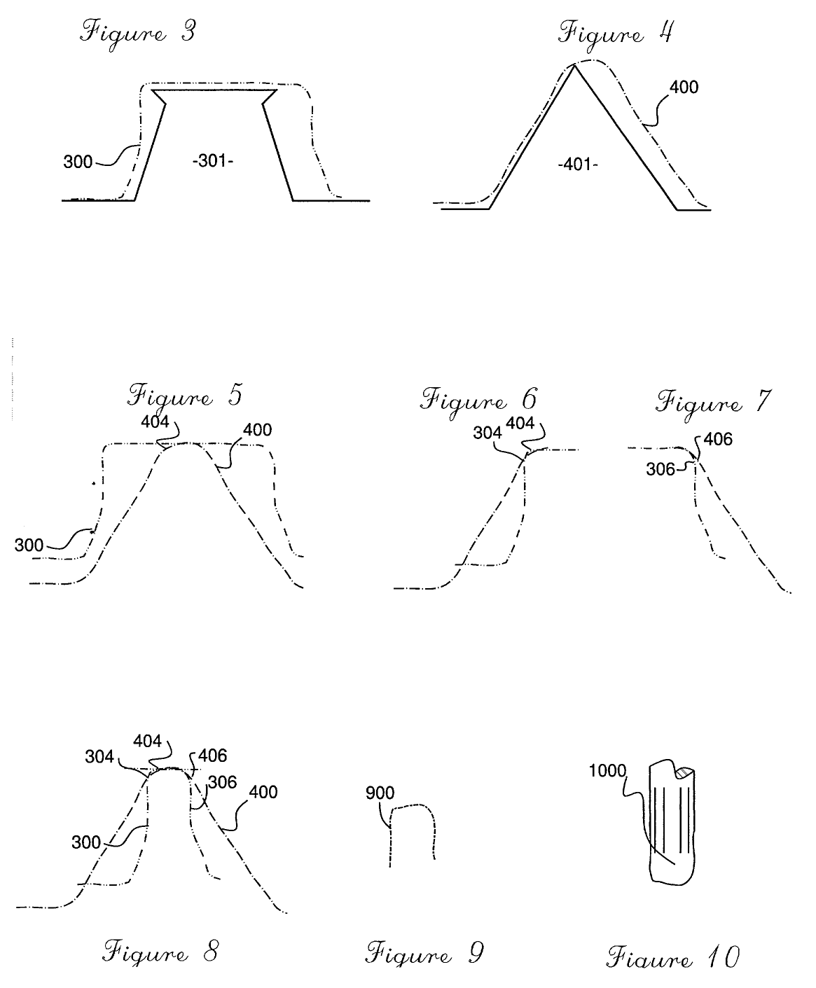

The first step is to set the matrix maxima points equal in the x-z plane. Once this is done, the function should have its contribution from the area where the curves overlap. If the scan line 300 of FIGS. 3 and 5 is split at the point of overlap and then translated to both the right and left, there should be an absolute minima in the inverse deviation sum squared calculation where the numbers fall off as the radius of curvature between the two point matrixes match. The progressive steps of matching region 304 of scan line 300 with the region 404 of scan line 400, and region 306 with the region 406 of scan line 400, are illustrated in FIGS. 5, 6 and 7. FIG. 8 is a representation of the function after it has been solved for its minima. It is made up of three point matrixes and the minima at each point then represents the tip structure. The calculation of the inverse deviation sum squared from the three matrix array then gives a functional value for the fit between the sidewall characterization matrix and the bottom characterization matrix. The resultant characterization is illustrated by line 900 of FIG. 9 and the probe 1000 is illustrated in FIG. 10.

Another aspect of the invention involves the determination of the changes over time of the solved tip characterization. This step involves assigning a value between two characterizations to indicate how well they match. This is done via algorithm thus removing the ambiguity of manual evaluations. This can be carried out via the use of a calculation of the deviation of the two matrixes at each point along the characterization pixel by pixel. The formularized number can then be monitored and can be used as an inline reference for indicating when a tip should be changed. This is of vital importance since a tip must remain constant through the scan to be able to remove the tip shape from the raw data. If the probe changes geometry during the scan, then the extraction of the shape of the real surface from the raw data becomes virtually impossible.

The present invention proves an automatic characterization of tips by scanning over two known structures and then working with the point matrices automatically. This removes the need for the user to manually pick the inflection pint along the sidewall slope of the nanoedge ridge and eliminates the ambiguity from characterization to characterization. Thus, one characterization can be reliably compared to another.

What is claimed is:

1. The method of characterizing the shape of a probe element for a scanning probe microscope, comprising the steps of:
a) scanning a first known surface, said first known surface having a plurality projections, each projection being an elongated member having an hour glass cross-section in a first plane, said first plane being parallel to the direction of scanning;
b) scanning a second known surface, said second known surface having a plurality projections, each projection being an elongated member having at least a triangular apex cross-section in a first plane, said first plane being parallel to the direction of scanning;
c) generating a first scan line during step (a), said first scan line having a first curve region generated during the movement of said probe up and over a first edge of said first known surface and said first scan line having a second curve region generated during the movement of said probe over and down past a second edge of said first known surface;
d) generating a second scan line during step (b), said second scan line having a first curve region generated during the movement of said probe up and over the apex of said second known surface and a second curve region generated during the movement of said probe over and down past the apex of said second known surface;
e) geometrically matching said first scan line first curve region and said second scan line first curve region,
f) geometrically matching said first scan line second curve region and said second scan line second curve region,
g) defining the shape of the probe surface by generating a probe characteristic representation curve from the geometric matching said first scan line first curve region and said second scan line first curve region and the geometric matching of said first scan line second curve region and said second scan line second curve region, wherein said probe characteristic representation curve is a graphic representation of the shape of the tip of said probe.

2. The method of claim 1, further comprising the steps of:
mathematically matching said first scan line with said second scan line by means of an equation that maximizes the overlap region formed by matching said first scan line first curve region with said second scan line first curve region and said first scan line second curve region with said second scan line second curve region.

3. The method of claim 2, wherein the mathematical algorithm calculates the inverse deviation sum squared value between the data of said first scan line and the data of said second scan line.

4. The method of claim 1, further comprising the step of said first scan line being split into a first curve region containing first section and a second curve region containing second section and wherein step (e) matches said first scan line first section with said second scan line first curve region and step (f) matches said first scan line second section with said second scan line second curve region.

5. The method of claim 3, wherein an absolute minima in the inverse deviation sum squared calculation is calculated when the radius of curvature between the two scan lines match.

6. The method of claim 1, further comprising the steps of repeating steps (a) through (g) at spaced time intervals, at each of said spaced time intervals assigning a value to the change of shape of the probe surface between two time intervals, comparing the time related changes in said value and thereby determining when the probe has varied to the extent that it should be replaced.

7. The method of claim 6, wherein said value is assigned between two probe characterizations on the basis of the degree to which said two probe characterization match.

8. The method of claim 7, wherein each scan line is a series of characterization pixels, and said value is determined by calculating the deviation between probe characteristic representation curves at each point along the characterization curves, pixel by pixel.

9. The method of characterizing the shape of a probe element for an electronic microscope, comprising the steps of:
a) scanning a first known surface, said first known surface having at least one projection, said at least one projection being a member having a flared upper end, said flared upper end having a pair of opposed edges, moving said probe element being in a first direction relative to said first known surface during a first stage of said scanning such that a side of said probe is proximate a first of said pair of opposed edges of said first known surface projection;
moving said probe element being in a second direction relative to said first known surface during a second stage of said scanning such that a side of said probe is proximate a second of said pair of opposed edges of said first known surface projection;
b) scanning a second known surface, said second known surface having at least one projection, said at least one projection having an apex at its upper end, said probe having a distal end, said distal end being proximate said apex during at least a portion of said scanning of said second known surface;
c) generating a first scan line during step (a), said first scan line having a first curve region generated during said first stage of said scanning and a second curve region is generated during said second stage of said scanning;
d) generating a second scan line during step (b), said second scan line having a first curve region generated during the movement of said probe up and over said apex of said second known surface and a second curve region generated during the movement of said probe over and down past said apex of said second known surface;
e) matching said first scan line first curve region and said second scan line first curve region,
f) matching said first scan line second curve region and said second scan line second curve region,
g) defining the shape of the probe surface by generating a probe characteristic representation curve from said matching of said first scan line first curve region with said second scan line first curve region and matching of said first scan line second curve region with said second scan line second curve region,
wherein said probe characteristic representation curve is a graphic representation of the shape of the tip of said probe.

10. The method of claim 9, further comprising the steps of:
mathematically matching said first scan line with said second scan line by means of an equation that maximizes the overlap region formed by matching said first scan line first curve region with said second scan line first curve region and said first scan line second curve region with said second scan line second curve region.

11. The method of claim 10, wherein the mathematical algorithm calculates the inverse deviation sum squared value between the data of said first scan line and the data of said second scan line.

12. The method of claim 9, further comprising the step of said first scan line being split into a first curve region containing first section and a second curve region containing second section and wherein step (e) matches said first scan line first section with said second scan line first curve region and step (f) matches said first scan line second section with said second scan line second curve region.

13. The method of claim 11, wherein an absolute minima in the inverse deviation sum squared calculation is calculated when the radius of curvature between the two scan lines match.

14. The method of claim 9, further comprising the steps of repeating steps (a) through (g) at spaced time intervals, at each of said spaced time intervals assigning a value to the change of shape of the probe surface between two time intervals, comparing the time related changes in said value and thereby determining when the probe has varied to the extent that it should be replaced.

15. The method of claim 14, wherein said value is assigned between two probe characterizations on the basis of the degree to which said two probe characterization match.

16. The method of claim 15, wherein each scan line is a series of characterization pixels, and said value is determined by calculating the deviation between probe characteristic representation curves at each point along the characterization curves, pixel by pixel.
